(19) United States
(12) Patent Application Publication
(10) Pub. No.: US 2010/0201263 A1
(43) Pub. Date: Aug. 12, 2010

(54) VACUUM DEGASSING BOX OF A FIELD EMISSION DISPLAY

(76) Inventors: Chuan-Chen CHEN, Guanyin Township (TW); Guo-Hua Chen, Guanyin Township (TW); Jin-Shou Fang, Guanyin Township (TW)

Correspondence Address: HDLS Patent & Trademark Services, P.O. BOX 220746, CHANTILLY, VA, 20153-0746, US

(21) Appl. No.: 12/369,827

(22) Filed: Feb. 12, 2009

(51) Int. Cl. H01J 19/70

(52) U.S. Cl. 313/561

(57) ABSTRACT

In a vacuum degassing box of a field emission display, the field emission display includes a faceplate, and the faceplate has a chamber and a through opening which is defined on the faceplate and communicated with the chamber. The vacuum degassing box includes a housing and a getter. The through opening of the faceplate is covered by the housing. A contained chamber is formed between the housing and the faceplate, and a rough surface is formed inside the contained chamber. The getter is distributed on the rough surface of the contained chamber. Therefore, a vacuum condition of the vacuum degassing box is kept for a long time to increase use life of the field emission display.

### BACKGROUND OF THE INVENTION

1. Field of the Invention

The present invention relates to a field emission display, and more particularly to a vacuum degassing box of a field emission display.

2. Description of Prior Art

In general, a field emission display keeps a specific vacuum condition inside its chamber to provide a free path after the chamber is vacuumed and packaged, so that an electron beam produced by a cathode plate can excite a phosphor layer of an anode plate to emit light. In the process of using a field emission display, the heat produced from exciting the phosphor will continuously produce a small quantity of gas in the chamber and affect the vacuum condition in the chamber to reduce the use life of the field emission display.

The conventional field emission display is comprised of a faceplate, a plurality of phosphor layers and a vacuum degassing box; wherein the faceplate is formed by stacking a node plate and a cathode plate, and a chamber is formed between the anode plate and the cathode plate, and a through opening is formed at the cathode plate and interconnected with the chamber. The phosphor layers are contained in the chamber and formed on the anode plate, and the vacuum degassing box includes a housing and a getter, wherein the housing is formed by injection molding or hot press forming method and covered and fixed onto the cathode plate, and the housing includes a contained chamber interconnected with the through opening, and the getter is distributed on a surface of the contained chamber for absorbing the small quantity of gas in the chamber.

However, the conventional field emission display still has the following drawbacks in practical applications, since the housing of the vacuum degassing box is formed by the injection molding or hot press forming method, and thus incurring much manufacturing time and high molding cost. In addition, the housing formed by injection molding comes with a limited surface of the contained chamber and allows a small quantity of getter distributed on the surface of the surface of the contained chamber, and thus such prior art cannot keep the vacuum condition inside the chamber for a long time, but will reduce the use life of the field emission display.

In view of the shortcomings of the prior art, the inventor of the present invention based on years of experience in the related industry to design a vacuum degassing box in accordance with the present invention to overcome the shortcomings of the prior art.

### SUMMARY OF THE INVENTION

It is a primary objective of the present invention to provide a vacuum degassing box of a field emission display, wherein the vacuum condition of the vacuum degassing box can be kept for a long time to increase use life of the field emission display.

Another objective of the present invention is to provide a vacuum degassing box of a field emission display, and the vacuum degassing box can be manufactured easily by a low manufacturing cost without requiring any mold.

To achieve the foregoing objectives, the present invention provides a vacuum degassing box of a field emission display, and the field emission display comprises: a faceplate, having a chamber and a through opening interconnected with the chamber, and the vacuum degassing box comprises a housing and a getter. The housing is covered and fixed at the through opening of the faceplate, and the housing includes a contained chamber formed by enclosing the faceplate, wherein a rough surface formed inside the contained, and the getter is disposed on the rough surface inside the contained chamber.

Compared with the prior art, the present invention has the rough surface formed inside the contained chamber of the housing of the vacuum degassing box to increase the surface area of the contained chamber to coat a larger quantity of getter, so as to achieve the effects of keeping the vacuum condition inside the chamber for a longer time and extending the use life of the field emission display. The present invention can overcome the shortcomings of the prior art that has a limited surface area of the contained chamber of the housing, only coats a small quantity of getter, maintains the vacuum conditions for a short time and a short use life of the field emission display.

In addition, the present invention simply requires forming a basic material on the contained chamber and the rough surface of the contained chamber by a sand blasting or etching method to form the housing, and thus incurring a simple manufacturing procedure, and a low cost without requiring any mold for the formation. Obviously, the present invention can save the manufacturing cost for preparing the molding for forming the housing and the high cost of the molds.

### BRIEF DESCRIPTION OF DRAWINGS

FIG. 1 is a perspective view of a vacuum degassing box of the present invention;

FIG. 2 is another perspective view of a vacuum degassing box of the present invention;

FIG. 3 is a cross-sectional view of Section 3-3 of FIG. 1;

FIG. 4 is an exploded view of a field emission display of the present invention;

FIG. 5 is a perspective view of an assembled field emission display of FIG. 4;

FIG. 6 is a cross-sectional view of Section 6-6 in a vacuum as depicted in FIG. 5; and

FIG. 7 is a cross-sectional view of sealing the vacuum as depicted in FIG. 6.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

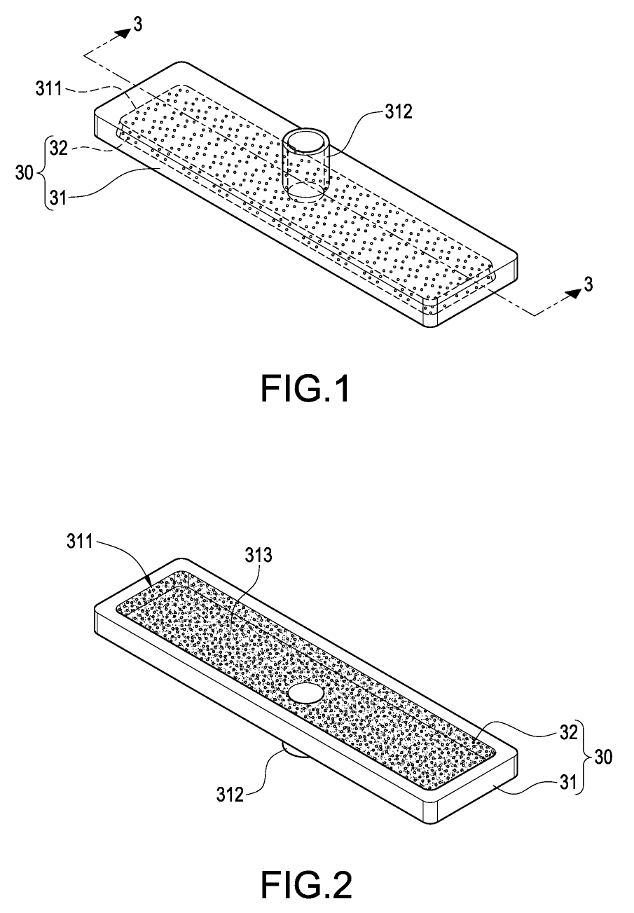

With reference to FIGS. 1 and 2 for a vacuum degassing box of a field emission display 30 in accordance with the present invention, the vacuum degassing box is comprised of a housing 31 and a getter 32.

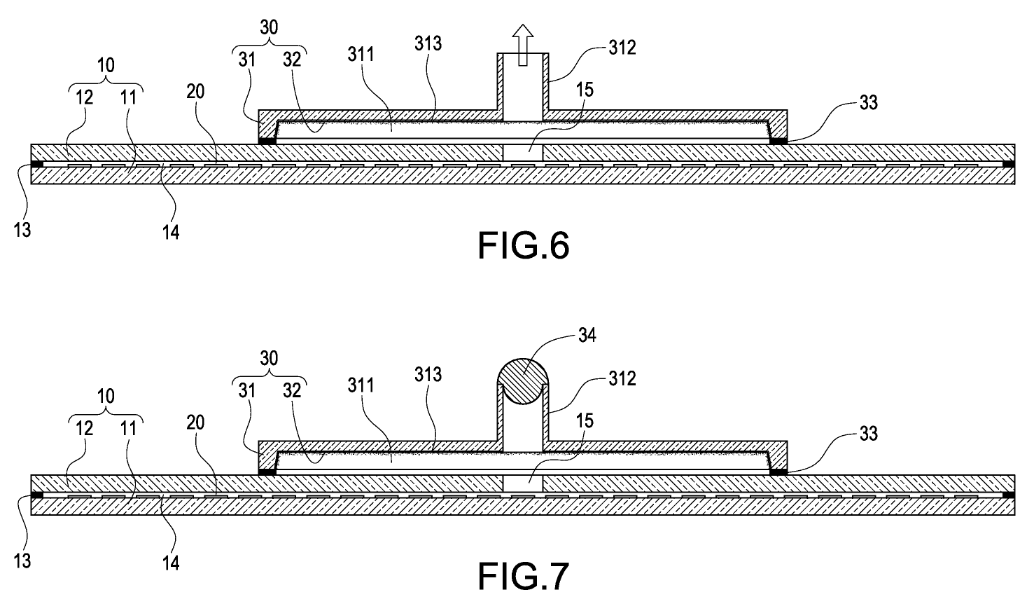

In FIG. 6, the field emission display 30 includes a faceplate 10, a plurality of phosphor layers 20 and the vacuum degassing box 30.

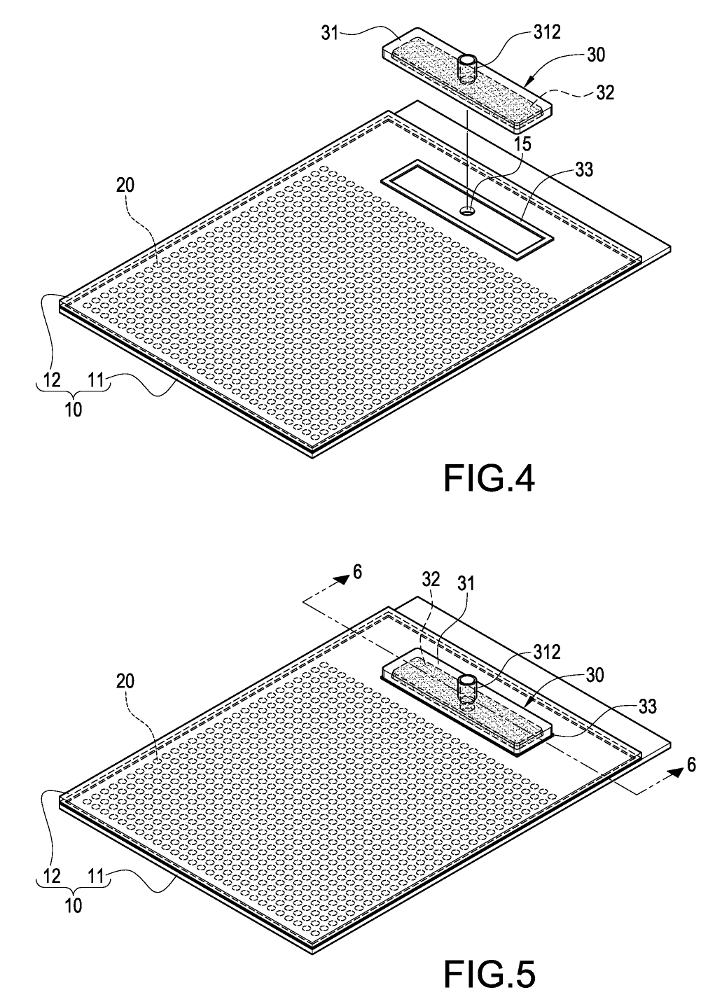

In FIGS. 4 and 5, the faceplate 10 is a rectangular glass plate, and the faceplate 10 is formed by stacking an anode plate 11 and a cathode plate 12, and forming a plurality of support layers (not shown in the figure) between the anode plate 11 and the cathode plate 12 for maintaining the necessary interval between the anode plate 11 and the cathode plate 12, an adhesive layer 13 (as shown in FIG. 6) for fixing the anode plate 11 and the cathode plate 12, and a chamber 14 formed between the anode plate 11 and the cathode plate 12, wherein the cathode plate 12 includes a through opening 15 interconnected with the chamber 14, and the chamber 14 includes a dielectric layer, a gate layer and an electron emitting source, etc (not shown in the figure), which are prior arts, and thus they will not be described her again, and the adhesive layer 13 can be a glass adhesive, but not limited to such arrangement only.

The phosphor layer 20 is contained inside the chamber 14 and formed on the anode plate 11 separately, and the phosphor layer 20 can be red phosphor powder, green phosphor powder, blue phosphor powder or their combinations, but not limited to such arrangement only.

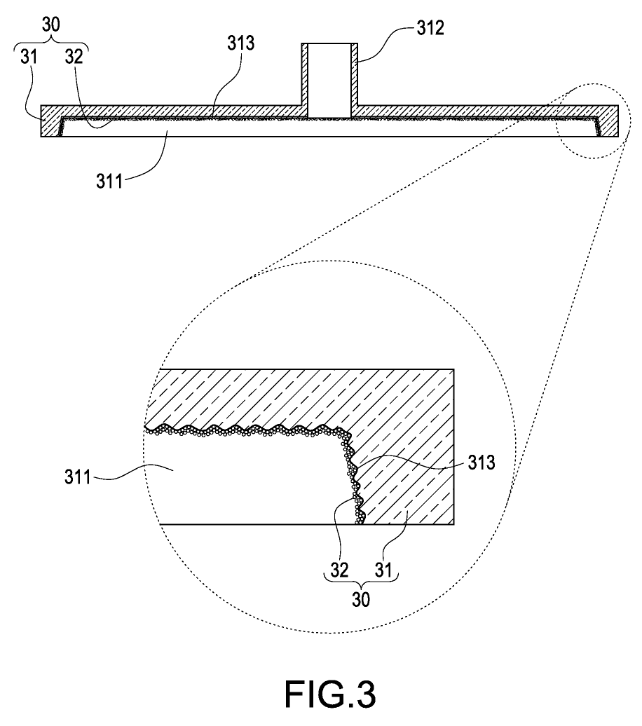

In FIGS. 1 and 2, the housing 31 is fixed onto the cathode plate 12 by an adhesive strip 33, wherein the adhesive strip 33 is a glass adhesive, but not limited to such arrangement only. The housing 31 is covered and fixed onto the through opening 15 of the faceplate 10, and the housing 31 includes a contained chamber 311 formed by enclosing the faceplate 10 and an air extraction tube 312 interconnected with the contained chamber 311, and a rough surface 313 (as shown in FIG. 3) is formed inside the contained chamber 311, and the rough surface 313 can be formed by a sand blasting or etching method, and the housing 31 is integrally formed and made of glass, but not limited to such arrangement only.

The getter 32 is coated onto the rough surface 313 inside the contained chamber 311 and preferably adhered onto the rough surface 313 of the contained chamber 311, and the getter 32 is provided for absorbing a small quantity of gas produced inside the chamber 14 and a heating element (not shown in the figure) is installed inside the contained chamber 311 for heating the getter 32 and activating the getter 32, wherein the getter 32 can be barium oxide, calcium oxide, barium alloy or a combination of the above. The getter 32 can be a non-vaporizing getter, but not limited to such arrangement only, and the heating element can be a resistor type heating element such as tungsten.

In a packaging procedure of the present invention as shown in FIGS. 6 and 7, an air extraction tube 312 and an external air pump (not shown in the figure) are connected, and then the contained chamber 311 and the chamber 14 are vacuumed, and finally an end of the air extraction tube 312 is sealed by an adhesive 34 or an end of the air extraction tube 312a is heated and melted to complete an airtight packaging of the present invention.

In addition, the packaging of the present invention may adopt the vacuum packaging process, wherein the sealed faceplate 10 and the housing 31 are placed in a vacuum packaging room, and then the vacuum packaging room is vacuumed by an air pump, and finally an adhesive strip 33 is used for sealing the faceplate 10 with the vacuum degassing box 30, so as to complete the sealing and packaging operation of the present invention.

After the packaging process of the invention is completed as shown in FIG. 7, a specific vacuum condition is kept inside the chamber 14 to provide a free path, such that electron beams produced by the cathode plate 12 can excite the phosphor layer 20 on the anode plate 11 to emit light, and a small quantity of gas produced continuously during the exciting process can be absorbed and eliminated by the getter 32 inside the contained chamber 311 of the housing 31, wherein the present invention forms the rough surface 313 inside the contained chamber 311 of the housing 31 to increase the surface area of the contained chamber 311, so as to coat a larger quantity of getter 32 to keep a vacuum condition inside the chamber 14 for a longer time and extend the use life of the field emission display.

In addition, the present invention can form the rough surface 313 on a basic material of the contained chamber 311 and the interior of the contained chamber 311 by a sand blasting or etching method, without requiring any mold to form the housing 31, and thus incurring an easy manufacturing procedure and a low cost.

It is noteworthy to point out that the rough surface 313 can be formed on the cathode plate 12 inside the contained chamber 311 by a sand blasting or etching method to increase the surface area of the contained chamber 311 to achieve the same effect of the aforementioned preferred embodiment.

In summation of the description above, the present invention can achieve the effects of keeping the vacuum condition inside the chamber 14 for a longer time, extending the use life of the field emission display, providing an easy manufacturing process with a low cost without requiring any mold for the manufacturing, and overcoming the shortcomings of the prior art. The invention complies with the requirements of patent application and is thus duly filed for patent application. While the invention has been described by means of specific embodiments, numerous modifications and variations could be made thereto by those skilled in the art without departing from the scope and spirit of the invention set forth in the claims.

What is claimed is:

1. A vacuum degassing box of a field emission display, and the field emission display including a faceplate, and the faceplate including a chamber and a through opening interconnected with the chamber, and the vacuum degassing box comprising:
a housing, covered and fixed at the through opening of the faceplate, and having a contained chamber formed by enclosing the faceplate, and a rough surface formed inside the contained chamber; and
a getter, coated inside the contained chamber.

2. The vacuum degassing box of a field emission display as recited in claim 1, wherein the housing is made of glass.

3. The vacuum degassing box of a field emission display as recited in claim 1, wherein the housing is formed integrally as a whole.

4. The vacuum degassing box of a field emission display as recited in claim 1, wherein the getter is one selected from the collection of barium oxide, calcium oxide, barium alloy and a combination of the above.

5. The vacuum degassing box of a field emission display as recited in claim 1, wherein the rough surface is formed by a sand blasting method.

6. The vacuum degassing box of a field emission display as recited in claim 1, wherein the rough surface is formed by an etching method.
